(19) United States
(12) Patent Application Publication
(10) Pub. No.: US 2011/0247186 A1
(43) Pub. Date: Oct. 13, 2011

(54) METHOD OF MANUFACTURING MULTILAYER CERAMIC CAPACITOR

(75) Inventors: Sang Yong Yu, Gyunggi-do (KR); Jin Won Park, Gyunggi-do (KR); Tak Gyum Kim, Gyunggi-do (KR)

(73) Assignee: SAMSUNG ELECTRO-MECHANICS CO., LTD., Gyunggi-do (KR)

(21) Appl. No.: 12/982,218

(22) Filed: Dec. 30, 2010

(30) Foreign Application Priority Data
Apr. 9, 2010 (KR) 10-2010-0032742

(51) Int. Cl. H01G 7/00

(52) U.S. Cl. 29/25.42

(57) ABSTRACT

A method of manufacturing a multilayer ceramic capacitor includes forming a base dielectric layer, forming a unit ceramic capacitor by alternately depositing internal dielectric layers and internal electrode layers on a top surface of the base dielectric layer, and stacking another unit ceramic capacitor on the unit ceramic capacitor, wherein the number of unit ceramic capacitors being stacked is two or more.

### CROSS-REFERENCE TO RELATED APPLICATIONS

This application claims the priority of Korean Patent Application No. 10-2010-0032742 filed on Apr. 9, 2010, in the Korean Intellectual Property Office, the disclosure of which is incorporated herein by reference.

### BACKGROUND OF THE INVENTION

1. Field of the Invention

The present invention relates to a method of manufacturing a multilayer ceramic capacitor, and more particularly, to a method of manufacturing a multilayer ceramic capacitor that has high strength while being capable of implementing super high capacitance.

2. Description of the Related Art

In general, a multilayer ceramic capacitor includes a plurality of ceramic dielectric sheets, and internal electrodes inserted between the plurality of ceramic dielectric sheets. A multilayer ceramic capacitor is currently in widespread use as a capacitive component for a variety of electronic devices due to its small size, high capacitance and ease of mounting on a substrate.

To cope with the current trend toward smaller and multi-functional electronic products, chip components are being reduced in size while having more functions. In response, multilayer ceramic capacitors are required to be smaller while realizing higher capacitance.

In order to increase the capacitance of a multilayer ceramic capacitor, dielectric layers interleaved with internal electrodes need to have a small thickness. To manufacture such dielectric layers, a method of forming green sheets using slurry is generally being used; however, it is difficult to achieve super high capacitance through the use of this method due to the inherent limitations in decreasing the thickness of the dielectric layers.

Furthermore, a multilayer ceramic capacitor, according to the related art, may be limited in the number of stacks thereof, be susceptible to damage from a physical shock, and experience interlayer cracks caused by a temperature change when multiple layers are deposited on a single dielectric.

Therefore, the development of a multilayer ceramic capacitor, capable of implementing super high capacitance while having a stable breaking strength, needs to be developed.

### SUMMARY OF THE INVENTION

An aspect of the present invention provides a method of manufacturing a multilayer ceramic capacitor having high strength while being capable of implementing super high capacitance.

According to an aspect of the present invention, there is provided a method of manufacturing a multilayer ceramic capacitor, the method including: forming a base dielectric layer; forming a unit ceramic capacitor by alternately depositing internal dielectric layers and internal electrode layers on a top surface of the base dielectric layer; and stacking another unit ceramic capacitor on the unit ceramic capacitor, wherein the number of unit ceramic capacitors being stacked is two or more.

The forming of the base dielectric layer may include forming a green sheet by using slurry formed of a dielectric material.

The forming of the unit ceramic capacitor may include performing deposition while moving a mask in a horizontal direction.

The mask may be aligned to a preset spot when the internal dielectric layer is deposited using a single mask. When the internal electrode layer is deposited, the mask may be moved from the preset spot to the left or right at a preset distance.

In the forming of the unit ceramic capacitor, the internal dielectric layer may have a particle size ranging from 1 nm to 30 nm, and a thickness ranging from 10 nm to 500 nm, and the internal electrode layer may have a particle size ranging from 1 nm to 5 nm, and a thickness ranging from 1 nm to 200 nm.

In the forming of the base dielectric layer, the base dielectric layer may have a particle size ranging from 150 nm to 300 nm and a thickness ranging from 1 um to 10 um.

The forming of the unit ceramic capacitor may be performed by using sputtering, pulsed laser deposition (PLD), e-beam evaporation, or thermal evaporation.

### BRIEF DESCRIPTION OF THE DRAWINGS

The above and other aspects, features and other advantages of the present invention will be more clearly understood from the following detailed description taken in conjunction with the accompanying drawings, in which:

FIGS. 1A through 1F are views sequentially illustrating a method of manufacturing a multilayer ceramic capacitor according to an exemplary embodiment of the present invention;

FIG. 2A is a view illustrating the process of depositing an internal dielectric layer by using a mask;

FIG. 2B is a view illustrating the process of depositing an internal electrode layer by using a mask;

FIG. 2C is a view illustrating the process of depositing an internal dielectric layer by using a mask; and

FIG. 3 is a cross-sectional view illustrating a multilayer ceramic capacitor manufactured by the method of manufacturing a multilayer ceramic capacitor according to an exemplary embodiment of the present invention.

### DETAILED DESCRIPTION OF THE PREFERRED EMBODIMENT

Exemplary embodiments of the present invention will now be described in detail with reference to the accompanying drawings. Moreover, detailed descriptions related to well-known functions or configurations will be ruled out in order not to unnecessarily obscure subject matters of the present invention.

The same or equivalent elements are referred to by the same reference numerals throughout the specification.

It will be understood that when an element is referred to as being “connected to” another element, it can be directly connected to the other element or intervening elements may also be present. In contrast, when an element is referred to as being “directly connected to” another element, there are no intervening elements present. In addition, unless explicitly described to the contrary, the word “comprise” and variations such as “comprises” “comprising,” will be understood to imply the inclusion of stated elements but not the exclusion of any other elements.

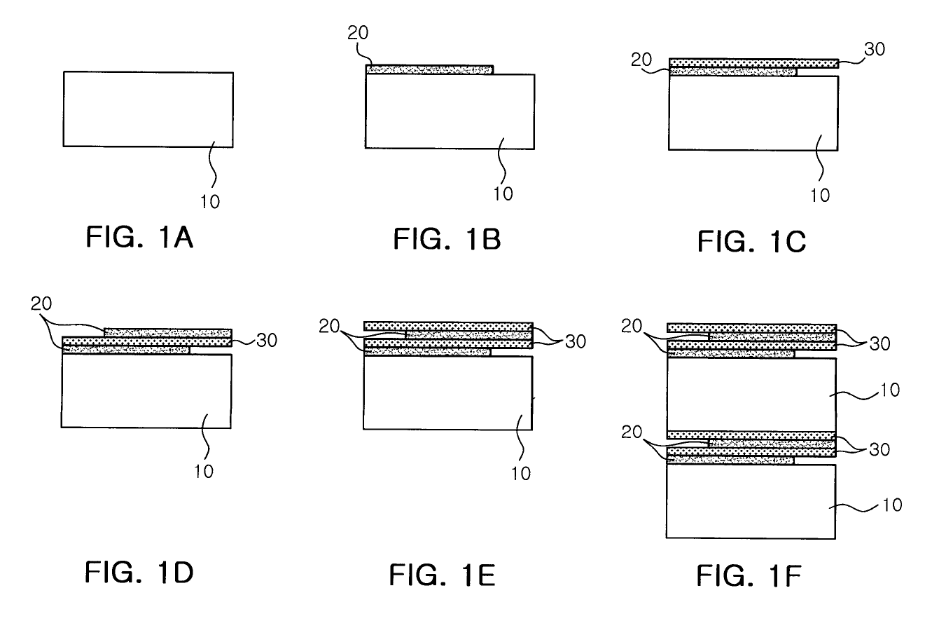

FIGS. 1A through 1F are views sequentially illustrating a method of manufacturing a multilayer ceramic capacitor according to an exemplary embodiment of the present invention.

Referring to FIG. 1A, the method of manufacturing a multilayer ceramic capacitor, according to an exemplary embodiment of the invention, may begin with providing a base dielectric layer 10.

The base dielectric layer 10 serves as a base for depositing a plurality of internal dielectric layers and a plurality of internal electrode layers on the top surface thereof. The base dielectric layer 10 may have a considerable thickness in order to enhance the strength of a multilayer ceramic capacitor.

The base dielectric layer 10 may be processed by a method of forming a green sheet using slurry of a dielectric material such as BaTiO₃.

In this case, a particle size of the dielectric material processed into the form of slurry may range about 150 nm to 300 nm, and the processed base dielectric layer 10 may range from about 1 um to 10 um.

FIG. 1B illustrates the process of forming an internal electrode layer 20 on the top surface of the base dielectric layer 10 prepared by the process illustrated in FIG. 1A.

The internal electrode layer 20 may have a very small thickness as it is formed by using a deposition method.

In detail, the deposition method may utilize a well-known vacuum deposition method such as sputtering, pulsed layer deposition (PLD), e-beam evaporation, thermal evaporation or the like.

The internal electrode layer 20, formed by the deposition method, may be made of nickel (Ni) or the like. Here, the material of the internal electrode layer 20 may have a particle size ranging from about 1 nm to 5 nm, and the thickness of the internal electrode layer 20 may range from about 1 nm to 200 nm.

By the use of the deposition method, the internal electrode layer 20 may have a very small thickness, which is advantageous in reducing the size of a multilayer ceramic capacitor.

According to this exemplary embodiment, the internal electrode layer 20 is formed directly on the top surface of the base dielectric layer 10. However, an internal dielectric layer may first be deposited on the top surface of the base dielectric layer 10, and the internal electrode layer 20 may be deposited thereon.

FIG. 1C illustrates the process of forming an internal dielectric layer 30 on the top surface of the internal electrode layer 20 formed in the process shown in FIG. 1B.

Since the internal dielectric layer 30 is also formed by a deposition method like the internal electrode layer 20 of FIG. 1B, the internal dielectric layer 30 may have a very small thickness.

In detail, the deposition process may utilize a well-known vacuum deposition method such as sputtering, pulsed laser deposition (PLD), e-beam evaporation, thermal evaporation or the like.

The internal dielectric layer 30, formed by the deposition method, may be made of BaTiO₃ or the like. The material of the internal dielectric layer 30 may have a particle size ranging from about 1 nm to 30 nm, and the thickness of the internal dielectric layer 30 may range from about 10 nm to 500 nm.

By forming the internal dielectric layer 30, the internal dielectric layer 30 may have a very small thickness, thereby allowing for the implementation of super high capacitance.

This thin internal dielectric layer 30 may also be advantageous in reducing the size of the multilayer ceramic capacitor.

FIGS. 1D and 1E illustrate the processes of depositing another internal electrode layer 20 on the deposited internal dielectric layer 30 of FIG. 1C, and the process of depositing another internal dielectric layer 30 thereon.

Such inner electrode layers 20 and inner dielectric layers 30 are alternately deposited on the top surface of the base dielectric layer 10, thereby manufacturing a unit ceramic capacitor.

According to this exemplary embodiment, the unit ceramic capacitor is illustrated as having two internal electrode layers 20 and two internal dielectric layers 30. However, the number of internal electrode layers 20 and the number of internal dielectric layers 30 may be changed freely as the occasion arises.

FIG. 1F illustrates the process of stacking two unit ceramic capacitors, manufactured in the above described manner with regard to FIGS. 1A through 1E.

By stacking a plurality of unit ceramic capacitors, the strength of the multilayer ceramic capacitor can be enhanced.

The internal dielectric layers 30, formed by deposition, may allow for the implementation of high capacitance. Furthermore, as a stack is formed to include two or more base dielectric layers 10, high strength can be obtained.

In addition, the base dielectric layer 10 may contribute not only to the strength of the multilayer ceramic capacitor but also to capacitance in part.

According to this exemplary embodiment, two unit ceramic capacitors are stacked. However, the number of unit ceramic capacitors may be changed freely according to need.

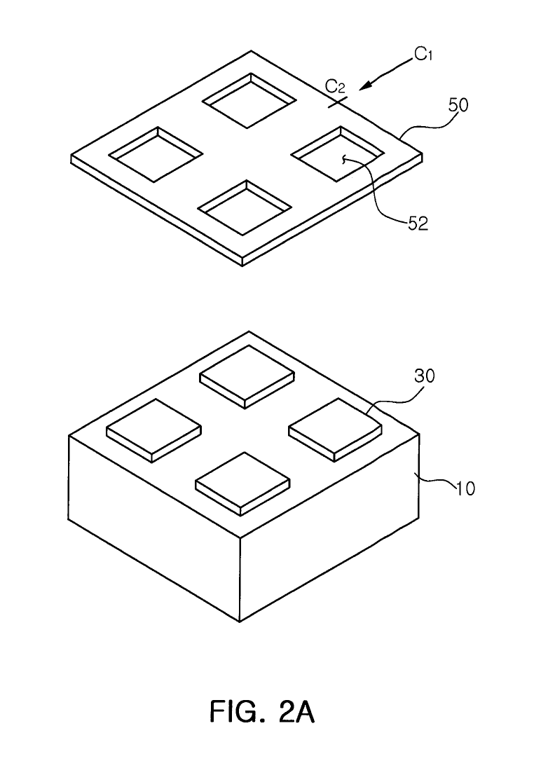

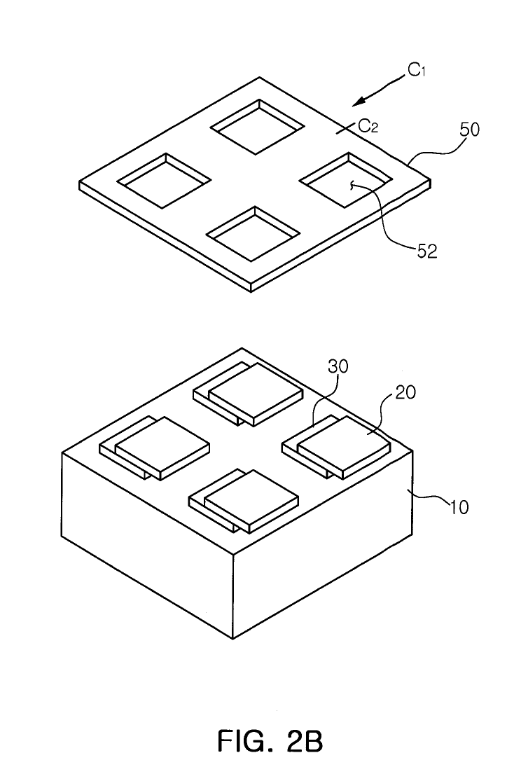

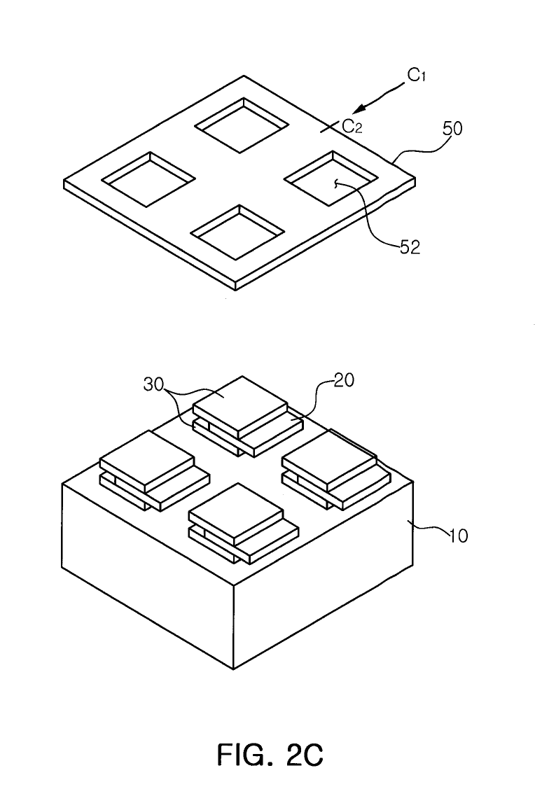

FIGS. 2A through 2C are views illustrating the process of depositing the internal dielectric layer and internal electrode layers in detail in the method of manufacturing a multilayer ceramic capacitor according to an exemplary embodiment of the present invention.

Referring to FIGS. 2A through 2C, in the process of depositing the internal dielectric layer and the internal electrode layer, a mask 50 having a plurality of openings 52 may be used.

FIG. 2A illustrates the process of depositing an internal dielectric layer 30 on the top surface of the base dielectric layer 10. Referring to FIG. 2A, when the internal dielectric layer 30 is deposited, the mask 50 may be aligned such that the center C2 of one side is placed at the same location as the center C1 of a corresponding side of the base dielectric layer 10.

In this state, the internal dielectric layer 30 may be deposited through the opening s52 of the mask 50.

FIG. 2B illustrates the process of depositing the internal electrode layer 20 on the internal dielectric layer 30. Referring to FIG. 2B, when the internal electrode layer 20 is deposited, the mask 50 may be moved in a horizontal direction such that the center C2 of the one side of the mask 50 is spaced apart from the center C1 of the corresponding one side of the base dielectric layer 10 at a predetermined distance.

FIG. 2C illustrates the process of depositing another internal dielectric layer 30 on the internal electrode layer 20 of FIG. 2B.

In this case, the mask 50 may be moved in a horizontal direction such that the center C2 of the one side of the mask 50 is placed at the center C1 of the corresponding one side of the base dielectric layer 10.

Although not shown in the drawing, the mask 50 is horizontally moved in a direction opposite to that of FIG. 2B, and the process of forming the internal electrode layer 20 is then repeated. In this way, the plurality of internal electrode layers 20 and the internal dielectric layers 30 may be deposited.

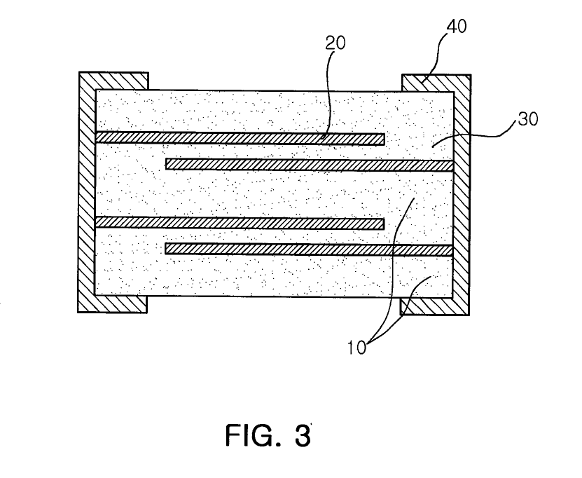

FIG. 3 is a cross-sectional view illustrating the multilayer ceramic capacitor manufactured by the method of manufacturing a multilayer ceramic capacitor according to an exemplary embodiment of the invention.

Referring to FIG. 3, the two or more unit ceramic capacitors that are stacked in the process of FIG. 1F is fired, and external electrodes 40 are formed, thereby completing the multilayer ceramic capacitor.

As set forth above, according to exemplary embodiments of the invention, the method of manufacturing a multilayer ceramic capacitor adopts a method of depositing dielectric layers and internal electrode layers on a base dielectric layer having a considerable thickness. Accordingly, very thin dielectric layers and internal electrode layers can be obtained, thereby allowing for the implementation of super high capacitance.

Furthermore, high breaking strength can be obtained by stacking two or more base dielectric layers, each of which has dielectric layers and internal electrodes layers deposited thereon.

While the present invention has been shown and described in connection with the exemplary embodiments, it will be apparent to those skilled in the art that modifications and variations can be made without departing from the spirit and scope of the invention as defined by the appended claims.

What is claimed is:

1. A method of manufacturing a multilayer ceramic capacitor, the method comprising:
forming a base dielectric layer;
forming a unit ceramic capacitor by alternately depositing internal dielectric layers and internal electrode layers on a top surface of the base dielectric layer; and
stacking another unit ceramic capacitor on the unit ceramic capacitor, wherein the number of unit ceramic capacitors being stacked is two or more.

2. The method of claim 1, wherein the forming of the base dielectric layer comprises forming a green sheet by using slurry formed of a dielectric material.

3. The method of claim 1, wherein the forming of the unit ceramic capacitor comprises performing deposition while moving a mask in a horizontal direction.

4. The method of claim 3, wherein the mask is aligned to a preset spot when the internal dielectric layer is deposited using a single mask,
when the internal electrode layer is deposited, the mask is moved from the preset spot to the left or right at a preset distance.

5. The method of claim 1, wherein, in the forming of the unit ceramic capacitor, the internal dielectric layer has a particle size ranging from 1 nm to 30 nm, and a thickness ranging from 10 nm to 500 nm, and
the internal electrode layer has a particle size ranging from 1 nm to 5 nm, and a thickness ranging from 1 nm to 200 nm.

6. The method of claim 1, wherein, in the forming of the base dielectric layer, the base dielectric layer has a particle size ranging from 150 nm to 300 nm and a thickness ranging from 1 um to 10 um.

7. The method of claim 1, wherein the forming of the unit ceramic capacitor is performed by using sputtering, pulsed laser deposition (PLD), e-beam evaporation, or thermal evaporation.
